(19) United States
(12) Patent Application Publication
(10) Pub. No.: US 2018/0322592 A1
(43) Pub. Date: Nov. 8, 2018

(54) SYSTEM AND METHOD FOR TRANSFERRING SERVICE PROVIDER INFORMATION

(71) Applicants: Dean Schiller, Burbank, CA (US); James Sepe, Burbank, CA (US)

(72) Inventors: Dean Schiller, Burbank, CA (US); James Sepe, Burbank, CA (US)

(21) Appl. No.: 15/971,064

(22) Filed: May 4, 2018

Related U.S. Application Data
(60) Provisional application No. 62/501,925, filed on May 5, 2017.

(51) Int. Cl. G06Q 50/06; G06Q 30/02; G06Q 30/04; H04W 4/24

(52) U.S. Cl. CPC G06Q 50/06; G06Q 30/0283; H04L 65/1096; H04W 4/24; G06Q 30/04

(57) ABSTRACT

A utility information system is disclosed. The utility information system has a data services module, comprising computer-executable code stored in non-volatile memory, a processor, and a notification device including one or more indicator display components that are user-visible. The data services module, the processor, and the notification device are configured to create a data packet including utility information, transfer the data packet from the data services module to the notification device, and control a display of the indicator display components, without user input, based on the data packet.

### RELATED APPLICATIONS

This application claims the benefit of U.S. Provisional Patent Application Ser. No. 62/501,925 filed May 5, 2017, which is hereby incorporated by reference in its entirety.

### TECHNICAL FIELD

The present disclosure generally relates to a system and method for transferring information, and more particularly to a system and method for transferring service provider information.

### BACKGROUND

Prices of many services offered by service providers such as utilities typically fluctuate, e.g., throughout a given day, week, and/or month. Various conventional techniques exist for notifying utility customers of pricing changes.

For example, one conventional technique includes informing customers of pricing changes in their monthly bills. However, this technique often fails to keep customers informed because the information provided in monthly bills is easily missed or ignored.

Another conventional technique includes allowing customers to login to web portals to access pricing schedules. However, this technique often fails to keep customers informed because it involves consumer action that may not be taken by many or most customers.

Another conventional technique includes educating customers via mailed paper schedules. However, this technique often fails to keep customers informed because the mailed schedules may be easily ignored or may not be opened.

Therefore, there currently exists a need in the industry for a system and method for communicating relative pricing rates to consumers and notifying consumers of pricing events and other utility information. The exemplary disclosed system and method are directed to overcoming one or more of the shortcomings set forth above and/or other deficiencies in existing technology.

### SUMMARY OF THE DISCLOSURE

In one exemplary aspect, the present disclosure is directed to a utility information system. The utility information system includes a data services module, comprising computer-executable code stored in non-volatile memory, a processor, and a notification device including one or more indicator display components that are user-visible. The data services module, the processor, and the notification device are configured to create a data packet including utility information, transfer the data packet from the data services module to the notification device, and control a display of the indicator display components, without user input, based on the data packet.

In another aspect, the present disclosure is directed to an apparatus. The apparatus includes a housing, one or more indicator display components that are disposed on a surface of the housing, and a communications assembly. The communications assembly is configured to receive a data packet. The data packet includes data indicating a first time period having a utility price that is lowest relative to a second time period. The first time period is shorter than the second time period and both begins and ends during the second time period. The one or more indicator display components operate to indicate when the first time period occurs.

### BRIEF DESCRIPTION OF THE DRAWINGS

FIG. 1 is a schematic view of an exemplary apparatus of the present invention;

FIG. 2 is a schematic view of an exemplary apparatus of the present invention;

FIG. 3 is a schematic view of an exemplary system of the present invention;

FIG. 4 illustrates an exemplary process of the present invention;

FIG. 5 illustrates an exemplary process of the present invention;

FIG. 6 illustrates an exemplary process of the present invention;

FIG. 7 illustrates an exemplary process of the present invention;

FIG. 8 is a schematic illustration of an exemplary computing device, in accordance with at least some exemplary embodiments of the present disclosure; and

FIG. 9 is a schematic illustration of an exemplary network, in accordance with at least some exemplary embodiments of the present disclosure.

### DETAILED DESCRIPTION AND INDUSTRIAL APPLICABILITY

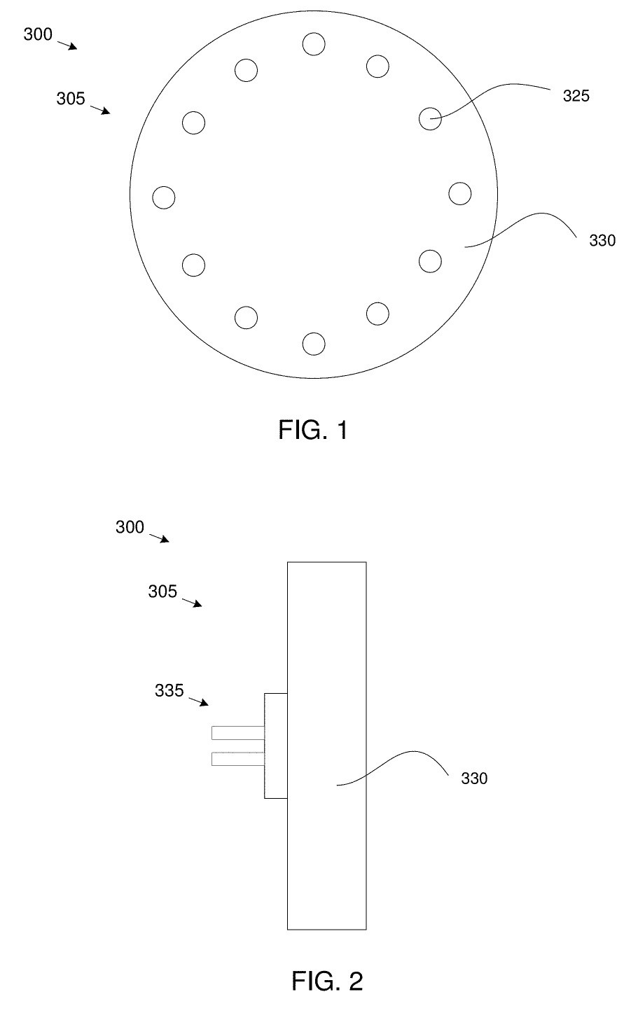

FIGS. 1-3 illustrate an exemplary system 300 for transferring service provider information. Exemplary system 300 may be, for example, an exemplary system for transferring service provider information such as, e.g., utility information. For example, system 300 may transfer utility information such as, e.g., pricing information and/or other utility information. For example, system 300 may transfer relative pricing information (e.g., relative utility pricing information). For example, system 300 may transfer information related to any suitable type of utility, e.g., an internet service provider, a cloud data storage provider, an entertainment service provider such as media and/or cable service provider, a communications service provider such as a voice communications service provider, an Internet of Things (IoT) service provider, an electric utility or power utility, a water utility, a gas or oil utility or service provider, a home security system service provider, a palliative care service provider, a health alert service provider, a home medical care service provider, and/or any other suitable service provider providing a service to a home, business, or other location for a fee. For example, system 300 may transfer information related to any service having a price subject to fluctuation over any suitable cycle or time period (e.g., subject to change several or many times each day, each week, each month, each year, and/or any other suitable time period). For example, system 300 may transfer information related to any service having, e.g., a price that fluctuates as a function of time (e.g., based on time of day, week, month, year, and/or any other suitable time period), weather, public holidays, scheduled events, a predetermined time schedule, peak and/or low usage periods, statutes and ordnances, and/or any other suitable criteria.

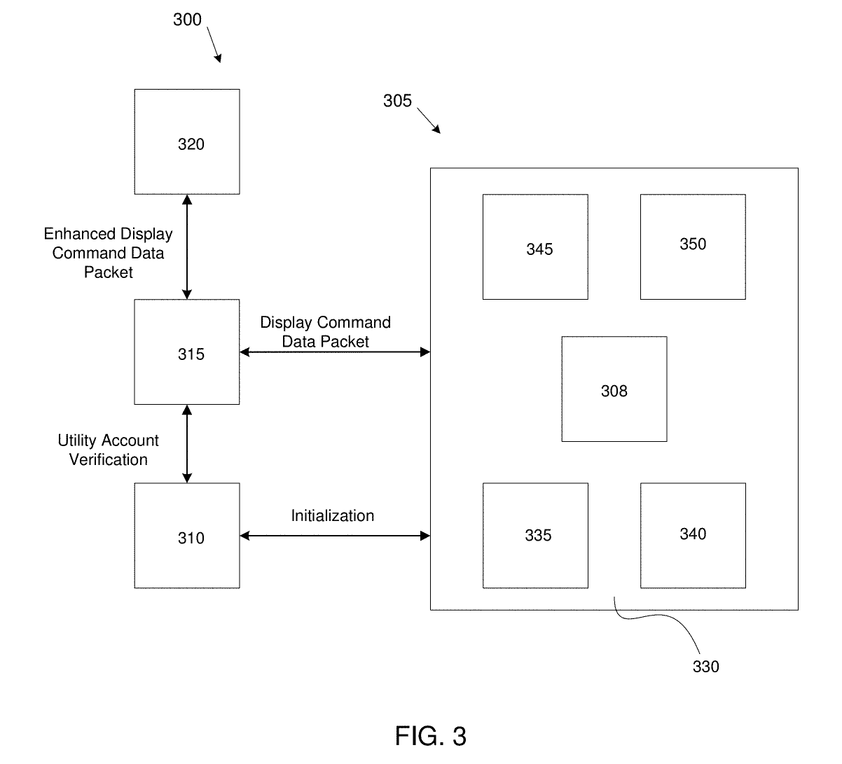

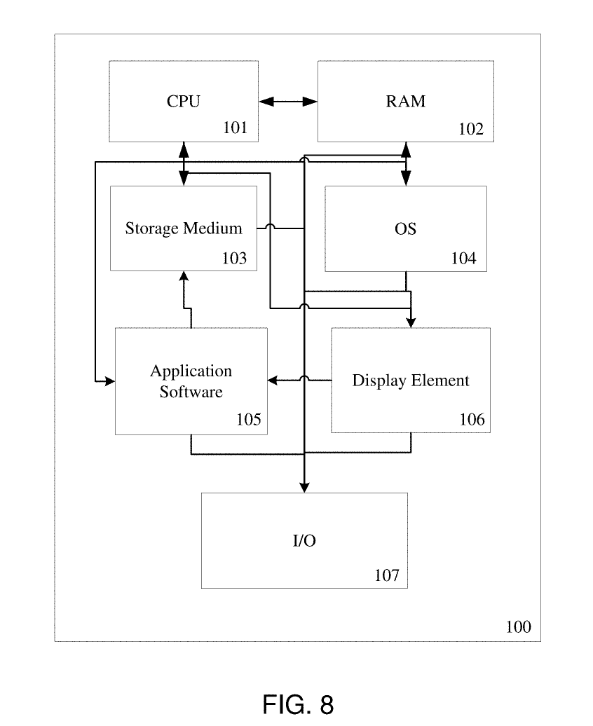

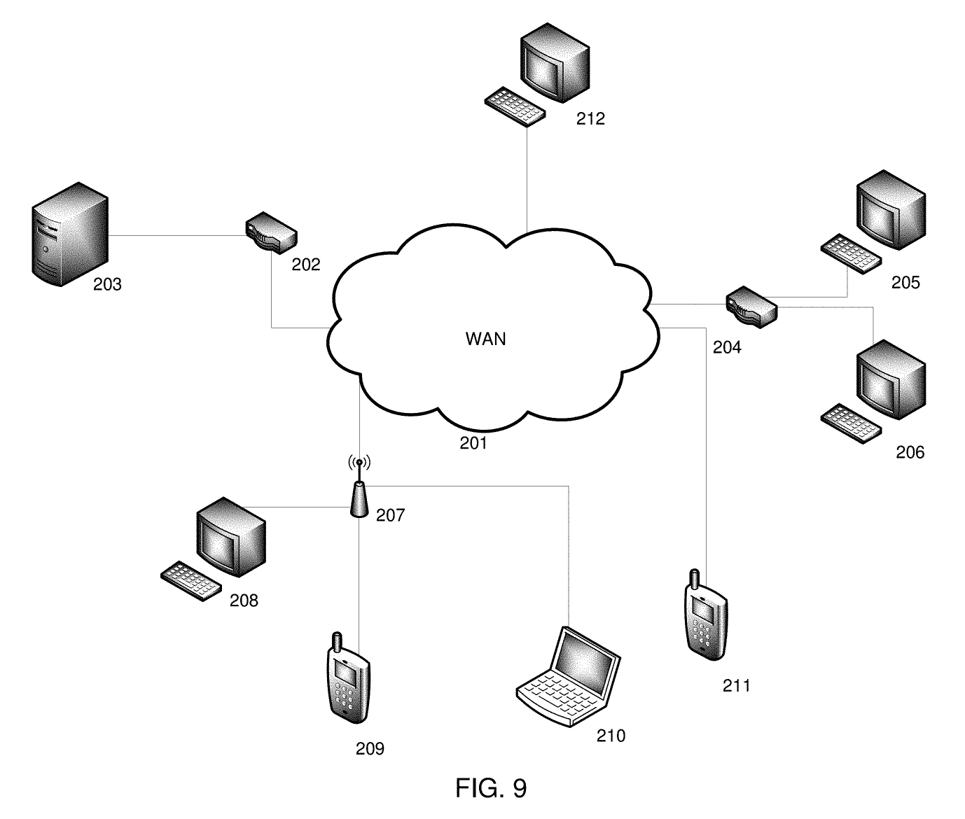

System 300 may for example include an assembly 305, a control application module 310, a data services module 315, and an enhanced display module 320. As illustrated in FIG. 3 and disclosed for example below, control application module 310 and data services module 315 may communicate with each other and with assembly 305, and enhanced display module 320 may communicate with data services module 315. For example and as disclosed further below, control application module 310 may facilitate an initialization of assembly 305. Also for example and as disclosed further below, control application module 310 and data services module 315 may communicate to perform a utility account verification process. Further for example and as disclosed further below, a display command data packet (e.g., and other exemplary data packets as disclosed for example below) may be transferred between data services module 315 and assembly 305. Also for example and as disclosed further below, an enhanced display command data packet may be transferred between data services module 315 and enhanced display module 320. Control application module 310, data services module 315, and enhanced display module 320 may have components similar to exemplary components disclosed for example below regarding FIGS. 8 and 9.

Data services module 315 may be for example a cloud-based module that sends display command data to assembly 305 via a communications module as disclosed for example below. For example, the display command data may be stored on assembly 305. The display command data may be read at predetermined intervals by assembly 305 and exemplary indicators (e.g., as disclosed below) of assembly 305 may be updated, e.g., accordingly.

Assembly 305 may be any suitable assembly for communicating information provided by system 300 to a user (e.g., a consumer or customer such as a utility customer). As illustrated in FIG. 3, assembly 305 may include a housing 330, a power assembly 335, a communications assembly 340, a display assembly 345, and an audio assembly 350. Communications assembly 340, display assembly 345, and audio assembly 350 may be housed partially or substantially entirely within housing 330. Power assembly 335 may for example be attached to a surface of housing 330 and/or may be partially embedded into housing 330 (e.g., or may be formed as an integral portion of housing 330).

Housing 330 may be any suitable structural assembly for containing and/or attachment of components of assembly 305. For example, housing 330 may be a structural assembly having any suitable shape (e.g., rectangular prism, cylindrical, cubic, and/or any other suitable shape) and including one or more cavities for housing components of assembly 305. Housing 330 may also be any suitable housing for protecting components of assembly 305 from the elements (e.g., precipitation, wind, exposure to heat and light, and/or any other environmental or manmade effects), and/or sealing interior cavities of housing 330 against the intrusion of debris and/or other undesirable material. Housing 330 (e.g., as well as other components of assembly 305) may be formed from any suitable materials for containing, protecting, and/or sealing components of assembly 305 such as, for example, polymer material, structural metal (e.g., structural steel), co-polymer material, thermoplastic and thermosetting polymers, resin-containing material, polyethylene, polystyrene, polypropylene, epoxy resins, phenolic resins, Acrylanitrile Butadiene Styrene (ABS), Polycarbonate (PC), Mix of ABS and PC, Acetal (POM), Acetate, Acrylic (PMMA), Liquid Crystal Polymer (LCP), Mylar, Polyamid-Nylon, Polyamid-Nylon 6, Polyamid-Nylon 11, Polybutylene Terephthalate (PBT), Polycarbonate (PC), Polyetherimide (PEI), Polyethylene (PE), Low Density PE (LDPE), High Density PE (HDPE), Ultra High Molecular Weight PE (UHMW PE), Polyethylene Terephthalate (PET), PolPolypropylene (PP), Polyphthalamide (PPA), Polyphenylenesulfide (PPS), Polystyrene (PS), High Impact Polystyrene (HIPS), Polysulfone (PSU), Polyurethane (PU), Polyvinyl Chloride (PVC), Chlorinated Polyvinyl chloride (CPVC), Polyvinylidenefluoride (PVDF), Styrene Acrylonitrile (SAN), Teflon TFE, Thermoplastic Elastomer (TPE), Thermoplastic Polyurethane (TPU), and/or Engineered Thermoplastic Polyurethane (ETPU), or any suitable combination thereof.

Assembly 305 may also for example include a controller 308 for controlling an operation of the components of assembly 305. Controller 308 may for example include a processor. Controller 308 may include for example a micro-processing logic control device or board components. Also for example, controller 308 may include input/output arrangements that allow it to be connected (e.g., via wireless and/or electrical connection) to other components of system 300 (e.g., via network communication and/or via direct communication). For example, controller 308 may control an operation of assembly 305 based on input received from system 300 via communications assembly 340. It is also contemplated that a user may control controller 308 via input entered via a user interface of assembly 305 (e.g., although assembly 305 may also operate without user input). For example, controller 308 may communicate with components of system 300 via wireless communication and/or via electrical lines (e.g., electrical line communication to components of assembly 305). It is also contemplated that controller 308 may control assembly 305 to act as an Internet of Things (IoT) device that may provide data to and/or be controlled by system 300 as a data-providing device.

Communications assembly 340 may be any suitable device for communicating data between assembly 305 and any other component of system 300. For example, communications assembly 340 may include any suitable transceiver device (e.g., transmitter device and/or receiver device) for transmitting data to and from other components of system 300 (e.g., to modules 310 and/or 315). For example, communications assembly 340 may receive and transmit data as disclosed below regarding exemplary communication techniques of FIG. 9. For example, communications assembly 340 may wirelessly send and receive data by any suitable technique such as, e.g., wirelessly transmitting data via 4G LTE networks (e.g., or any other suitable data transmission technique for example via network communication). Communications assembly 340 may send and receive data at any desired time interval (e.g., at constant or varying intervals and/or substantially continuously). Communications assembly 340 may for example be located inside housing 330 and may communicate with control application module 310 over a local network for initial configuration of assembly 305 as disclosed for example below.

Power assembly 335 may be attached to and/or disposed partially, mostly, or substantially entirely within housing 330 and may supply operating power to assembly 305. Power assembly 335 may be any suitable power source for providing energy to power an operation of components of assembly 305. For example, power assembly 335 may be an electric power source such as an electric plug. Power assembly 335 may be any desired type of electrical outlet plug such as, for example, a Type A plug, a Type B plug, a Type C plug, a Type D plug, a Type E plug, a Type F plug, a Type G plug, a Type H plug, a Type I plug, a Type J plug, a Type K plug, a Type L plug, a Type M plug, a Type N plug, and/or a Type 0 plug having any desired configuration for providing desired voltage, current, and/or grounding. Power assembly 335 may also include, for example, an electric power storage device, a solar-powered power storage device, and/or any other suitable type of power source. For example, power assembly 335 may include any suitable type of battery for powering components of assembly 305. For example, power assembly 335 may include a primary cell battery and/or a secondary cell battery. Also for example, power assembly 335 may include a lithium battery, an alkaline battery, a nickel-cadmium battery, and/or a zinc-carbon battery.

Audio assembly 350 may be any suitable assembly for selectively emitting an audible tone to alert a user (e.g., a consumer or customer) of an event and/or a change in service provider information. For example, audio assembly 350 may include any suitable type of electroacoustic device such as, for example, an electroacoustic transducer. For example, audio assembly 350 may include a piezoelectric device and/or any other suitable device for emitting an audio tone having, e.g., wide sound dispersion. For example, audio assembly 350 may selectively emit an audio signal or tone (e.g., a chirping sound or any other suitable audio alarm). It is also contemplated that audio assembly 350 may also include additional and/or alternative components for warning a user (e.g., customer) such as a visual alert utilizing flashing lights, strobe lights, and/or any other suitable warning technique.

Display assembly 345 may be any suitable assembly for alerting a user and/or providing information to a user. Components of display assembly 345 may be disposed on or at a surface of housing 330. For example as illustrated in FIG. 1, display assembly 345 may include one or more indicators 325. Indicators 325 may for example be disposed on a surface of housing 330 that is visible to a user. Indicators 325 may be any suitable component for alerting a user and/or conveying information to a user. For example, each indicator 325 may be a lighting element configured to emit light of varying intensity (e.g., luminance) and/or color to alert and/or inform a user of a given event and/or situation regarding pricing and other information related to a service (e.g., a utility service or other service). For example, each indicator 325 may display light of variable intensity, variable colors, and/or flashing light (e.g., or light of substantially constant luminance). For example, each indicator 325 may include one or more LED lights and/or any other suitable lighting element. Indicators 325 may be disposed in any desired configuration on housing 330 that is, e.g., suitable for warning and/or conveying information to a user. Indicators 325 may be, for example, analog or digital display elements. For example, each indicator 325 may include a display for providing information to a user. For example, indicators 325 may be digital displays and/or analog display screens for alerting and/or conveying information to a user. It is also contemplated that indicators 325 may include audio elements for additionally or alternatively providing audio alerts and/or information to a user. For example, indicators 325 may provide audio (e.g., or visual) information to a user if pressed or actuated by a user. Indicators 325 may also operate together to alert and/or convey information to a user based on an overall pattern of lighting and/or audio alerts provided by some or all indicators 325. Also for example, indicators 325 may be replaced or augmented with a display such as, e.g., a digital display.

Display assembly 345 and/or enhanced display module 320 may include an enhanced display that may provide enhanced (e.g., detailed) information to a user. For example, the exemplary enhanced display may be a user interface that may provide enhanced (e.g., detailed) information to a user. For example, the enhanced display may be included on a surface portion of assembly 305 that is visible to a user and/or may be remotely available to a user via any suitable device that is in communication (e.g., network communication) with system 300. For example, the exemplary enhanced display may include any suitable user interface for receiving input and/or providing output (e.g., raw data and/or results of predictive analysis) to a user. For example, the exemplary enhanced display may be in communication with system 300 and may include, for example, a touchscreen device (e.g., of a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user interface designed to work specifically with other components of system 300, and/or any other suitable user interface (e.g., including components and/or configured to work with components described below regarding FIGS. 8 and 9). For example, the exemplary enhanced display may be located remotely from assembly 305. For example, the exemplary enhanced display may include a touchscreen device of a smartphone or handheld tablet. For example, the exemplary enhanced display may include a display (e.g., a computing device display, a touchscreen display, and/or any other suitable type of display) that may provide raw data and/or predictive analysis results to a user. Also for example, the exemplary enhanced display may include a graphical user interface to facilitate entry of input by a user and/or receiving output. For example, a user may utilize the exemplary enhanced display to query raw data results and/or enter parameters to define a set of desired output. Also for example, system 300 may provide alerts to a user via output transmitted to the exemplary enhanced display (e.g., alerts pushed to a user via the exemplary enhanced display). System 300 may also send such alerts to a user by alternative methods such as, for example, via text message, email, and/or recording sent by telephone (e.g., in addition to alerts emitted by assembly 305 and/or the exemplary enhanced display as disclosed for example herein).

Assembly 305 may be attached to any desired object such as, for example, a wall, a ceiling, furniture, a door, and/or any other desired location by any suitable technique. For example, assembly 305 may be attached to an electrical outlet via power assembly 335 that may be an electrical plug as disclosed, e.g., above. Housing 330 may also include any suitable attachment device for attaching assembly 305 to a desired object. For example, housing 330 may include any suitable attachment device for attaching assembly 305 such as, e.g., a threaded attachment device, a bolted attachment device, a snap-fit attachment device, a friction-fit attachment device, an adhesive attachment device, a hook and loop attachment device, a magnetic attachment device, a clamping device, and/or any other suitable attachment device.

Assembly 305 may for provide a tangible device that may be displayed (e.g., prominently displayed) in a user's (e.g., consumer such as a utility customer) home or workplace. Assembly 305 may involve no actions or active performance of tasks by a user. For example, assembly 305 may be constantly active (e.g., turned on) and able to communicate a current relative utility price and/or other utility information and may be automatically updated by system 300 with changes in time, days, special events, and/or any other suitable updates. Also for example, assembly 305 may display relative utility pricing for a desired time period (e.g., rolling predetermined time period), may display relative pricing and/or other utility information in an automatic and continuous manner, and/or may provide alerts to consumers of pricing changes, energy events, and/or utility information.

Assembly 305 may for example be used (e.g., by a consumer) to know when the lowest relative price is available or will be available and/or when to conserve resources (e.g., conserve energy). For example, at 6 p.m. on a given day, assembly 305 may indicate that a price for electricity will be relatively lower at 8 p.m. (e.g., based on any predetermined configuration of indicators 325 recognizable by the user), thereby allowing the consumer to delay usage of energy devices (e.g., pool pump, washing machine, electric vehicle charging, and/or any other energy device). Assembly 305 may also alert a user that an energy event is occurring or going to occur, thereby allowing the user an opportunity (e.g., suggesting to the user) to access enhanced display module 320 (e.g., via the exemplary enhanced display disclosed for example herein) to learn more information about the energy event. Assembly 305 may also communicate other utility information to the user (e.g., when to water the user's lawn and/or when to charge the user's electric vehicle and/or other applicances).

Assembly 305 may for example be activated by using control application module 310. Once assembly 305 is able to communicate to a network (for example as disclosed herein, e.g., the Internet), the cloud-based data services module 315 may generate and download one or more data packets to control behavior of indicators 325 based on for example specific utility relative pricing and/or pricing scheduling information for a user such as a service provider customer. Assembly 305 may then automatically update indicators 325 to display a current pricing tier or information (e.g., at a current time) and then automatically update indicators 325 at predetermined intervals (for example, every hour or any other desired constant and/or variable interval). If desired, audio assembly 350 may emit an audible tone (e.g., alert) to indicate changes or other information worthy of a customer's attention. Also for example, assembly 305 may communicate to a user when the lowest relative price is or will be available, when there is an energy event, when to conserve (e.g., refrain from or limit usage), and/or provide other utility information as disclosed for example herein.

For example, the exemplary disclosed system may include a data services module (e.g., data services module 315), comprising computer-executable code stored in non-volatile memory, a processor (e.g., a processor for example included in or integrated with controller 308, other components of assembly 305, and/or data services module 315), and a notification device (e.g., assembly 305) including one or more indicator display components (e.g., indicators 325) that are user-visible (e.g., visible to a user). The data services module, the processor, and the notification device may for example be configured to create a data packet (e.g., display command data packet, updated display command data packet, updated enhanced display command data packet, event display command data packet, and/or enhanced event display command data packet) including utility information, transfer the data packet from the data services module to the notification device, and control a display of the indicator display components, without user input, based on the data packet. The utility information may for example include a utility pricing schedule. The notification device may for example include an audio assembly configured to emit an audio alert. The data services module, an enhanced display module (e.g., enhanced display module 320), the processor, and the notification device may for example be configured to create an enhanced data packet including the utility information and additional information. The enhanced data packet may for example be transferred to an enhanced display (e.g., an exemplary enhanced display as disclosed for example herein) that is located remotely from the notification device. The data services module, the processor, and the notification device may for example be configured to create a second data packet including updated utility information. The utility information may for example include a variable utility pricing Time of Use schedule describing pricing based on the time of day that utility services are consumed. The utility information may include a scheduled energy event. The exemplary disclosed system may also include a control application module that provides network credentials to the notification device. The utility information may also include electric utility information or water utility information.

The exemplary disclosed apparatus (e.g., apparatus 305) may include a housing (e.g., housing 330), one or more indicator display components (e.g., indicators 325) that are disposed on a surface of the housing, and a communications assembly (e.g., communications assembly 340). The communications assembly may be configured to receive a data packet (e.g., display command data packet, updated display command data packet, updated enhanced display command data packet, event display command data packet, and/or enhanced event display command data packet). The data packet may include data indicating a first time period having a utility price that is lowest relative to a second time period. The first time period may be shorter than the second time period and may both begin and end during the second time period. The one or more indicator display components may operate to indicate when the first time period occurs. The utility price that is lowest relative to the second time period may be an electricity price.

The exemplary disclosed system and method may be used in any suitable application for transferring service provider information. For example, the exemplary disclosed system and method may be used to transfer pricing and/or other information related to any suitable type of utility, e.g., an internet service provider, a cloud data storage provider, an entertainment service provider such as media and/or cable service provider, a communications service provider such as a voice communications service provider, an Internet of Things (IoT) service provider, an electrical utility, a water utility, a gas or oil utility or service provider, a home security system service provider, a palliative care service provider, a health alert service provider, a home medical care service provider, and/or any other suitable service provider providing a service to a home, business, or other location for a fee. Also for example, the exemplary disclosed system and method may be used to transfer information related to any service having a price subject to fluctuation over any suitable cycle or time period (e.g., subject to change several or many times each day, each week, each month, each year, and/or any other suitable time period). For example, the exemplary disclosed system and method may transfer information related to any service having, e.g., a price that fluctuates as a function of time (e.g., based on time of day, week, month, year, and/or any other suitable time period), weather, public holidays, scheduled events, a predetermined time schedule, peak and/or low usage periods, statute, and/or any other suitable criteria.

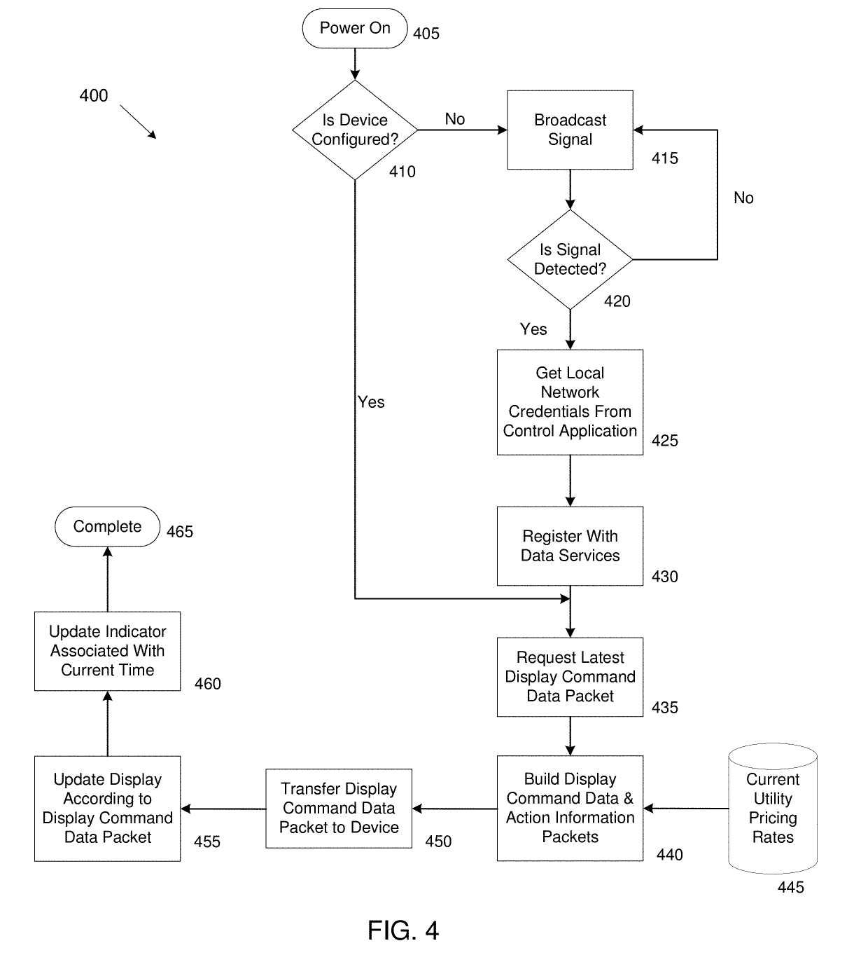

Examples of operation of the exemplary system and method will now be described. For example, FIG. 4 illustrates an exemplary process 400 describing a power on sequence of system 300. Process 400 begins at step 405. Upon power being applied to assembly 305, a check may be performed at step 410 to determine if assembly 305 has previously been configured to join the local network (e.g., the local network through which assembly 305 communicates with other components of system 300). If assembly 305 has not been previously configured, a broadcast signal (e.g., a continuous signal) may be broadcast (e.g., by assembly 305) at step 415. At step 420, system 300 may determine whether the signal (e.g., broadcast by assembly 305) has been detected. If the signal is not detected, process 400 returns to step 415. Once control application module 310 detects the signal (e.g., broadcast by assembly 305), control application module 310 may pass local network credentials (e.g., credentials of system 300) to assembly 305 at step 425. Assembly 305 may join the local network of system 300, and may register with data services module 315 at step 430. Assembly 305 may request a latest (e.g., most recent and up-to-date) display command data packet at step 435. If assembly 305 had been determined as previously configured at step 410, process 410 may proceed directly from step 410 to step 435.

At step 440, data services module 315 may build display command data and action information packets based on current utility pricing rates obtained (e.g., by accessing databases stored and/or accessed by system 300) at step 445. Data services module 315 may match assembly 305 to appropriate service provider information based on e.g. user-established criteria and/or predetermined parameters (e.g., assembly 305 may be matched with a utility pricing plan or other utility usage information). Data services module 315 may then convert the utility pricing plan or other utility usage information to a list of display behaviors and store this data in the display command data packet. The display command data packet may then be transferred to assembly 305 at step 450.

At step 455, assembly 305 may receive and read the display command data packet. Assembly 305 may then update display assembly 345 (e.g., including lighting display settings of indicators 325) based on the display command data packet. Once assembly 305 been updated, indicators 325 will be set to an updated behavior based on the current time (e.g., based on the actual time and the display command data packet) at step 460. For example, behaviors (e.g., lighting color, intensity, and/or flashing or steady lighting) of indicators 325 may be set based on the display command data packet. Also for example, audio assembly 350 may emit an audio warning to a user based on the specified behavior. Process 400 ends at step 465.

For example, upon applying power to assembly 305, a wireless signal may begin broadcasting (e.g., assembly 305 may begin broadcasting a signal such as a wireless signal). Control application module 310 may be configured to search for a device-generated signal (e.g., a signal generated by assembly 305). Once control application module 310 detects the signal (e.g., the wireless signal generated by assembly 305), pre-programmed data keys may be exchanged to create a secure connection between assembly 305 and control application module 310. A user (e.g., consumer such as a utility sustomer) may then enter (e.g., using a user interface and/or exemplary enhanced display as disclosed e.g. herein) their local network access point credentials, which may be transferred to assembly 305. Assembly 305 may then connect to the user's network (e.g., a home or business network of the user with which system 300 may communicate and/or be integrated with) and register with (e.g., cloud-based) data services module 315. Data services module 315 may read for example a current utility price schedule or other utility information and build a display command data packet. The display command data packet may define the behavior of indicators 325. Also for example, the display command data packet may be transferred to assembly 305. Assembly 305 (e.g., display assembly 345) may read the new display command data packet and update indicators 325 accordingly. For example, the behavior of a given indicator 325 indicating a current period may be differentiated from other indicators 325.

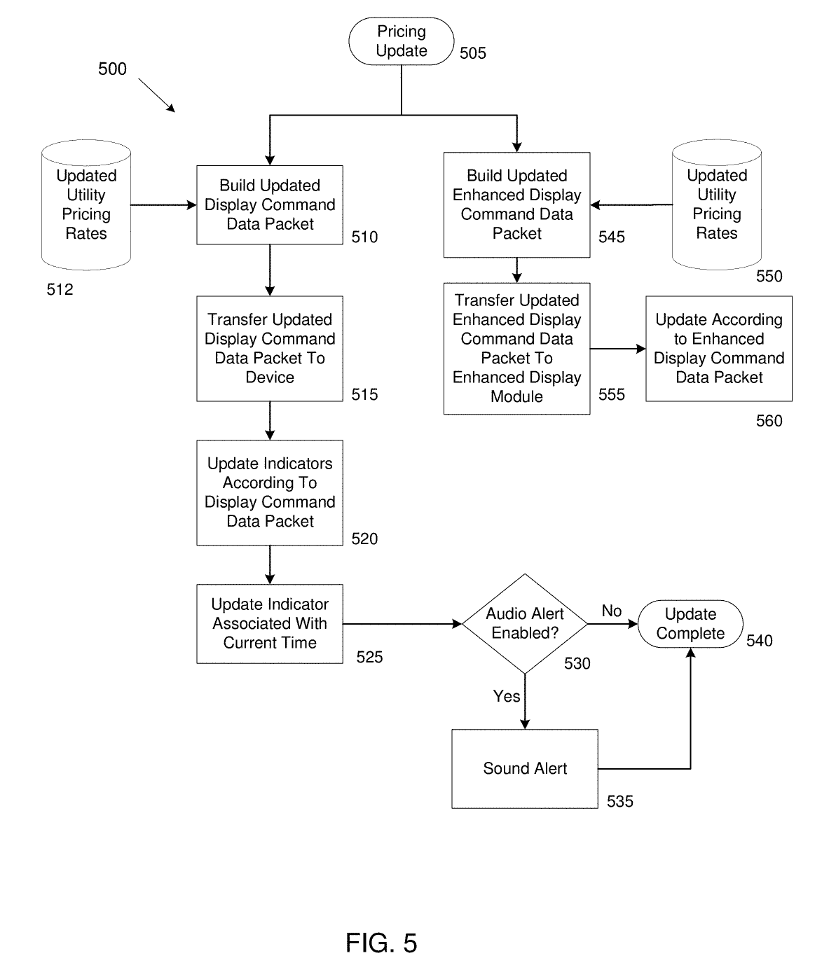

FIG. 5 illustrates an exemplary process 500 describing a price change sequence of system 300. Process 500 begins at step 505. When a new pricing schedule is established by the service provider (e.g., utility), data services module 315 may convert a utility pricing plan to a list of display behaviors and store them in a display command data packet. For example, data services module 315 may build an updated display command data packet at step 510 based on updated utility pricing rates obtained (e.g., by accessing databases stored and/or accessed by system 300) at step 512. At step 515, the display command data packet may then be transferred by system 300 to assembly 305.

Upon receipt of the display command data package, assembly 305 may read the display command data packet, decode the commands included in the display command data packet, and set (e.g., update) display assembly 345 (e.g., including indicators 325) based on the behaviors specified by the display command data package at step 520. For example, assembly 305 may update display assembly 345 (e.g., including lighting display settings of indicators 325) based on the display command data packet. Once assembly 305 been updated, indicators 325 may be set to an updated behavior based on the current time (e.g., based on the actual time and the display command data packet) at step 525. For example, behaviors (e.g., lighting color, intensity, and/or flashing or steady lighting) of indicators 325 may be set based on the display command data packet. Also for example, system 300 may determine at step 530 whether or not audio assembly 350 has been set to provide an audio alert. If audio assembly 350 has been set to emit an alert (e.g., an audio alert or any other suitable type of alert as disclosed, e.g., above), audio assembly 350 may emit an audio alert at step 535. For example, audio assembly 350 may emit an audio warning to a user based on the specified behavior disclosed for example above (e.g., indicating that a new pricing schedule is in effect). Process 500 may end at step 540.

Also for example in process 500, data services module 315 may create an enhanced display command data packet that contains for example the display command data packet as well as additional information (e.g., additional information regarding a price change such as a utility price change) at step 545 based on updated utility pricing rates obtained (e.g., by accessing databases stored and/or accessed by system 300) at step 550. The enhanced display command data packet may be transferred from data services module 315 to enhanced display module 320 at step 555. For example, enhanced display module 320 may be updated at step 560 based on the enhanced display command data packet. For example, the exemplary enhanced display disclosed for example herein may provide users (e.g., a consumer such as a utility customer) with additional information (e.g., information regarding a utility price change).

For example, when a change occurs in pricing such as in a utility price schedule (e.g., holidays or seasonal changes), data services module 315 may read the new utility price schedule and build a display command data packet and enhanced display command data packet. The display command data packet may for example define the behavior of indicators 325. The enhanced display command data packet may include the display command data packet plus augmented information regarding a pricing change such as the utility price schedule change. The display command data packet may be transferred to assembly 305. Assembly 305 (e.g., display assembly 345) may read the new display command data packet and update indicators 325 accordingly. The enhanced display command data packet may be transferred to enhanced display module 320 for example to mirror the display command data packet information as well as the augmented information. If audio assembly 350 is for example active, an audio tone may be emitted to alert a user (e.g., such as a utility customer) of the change in price.

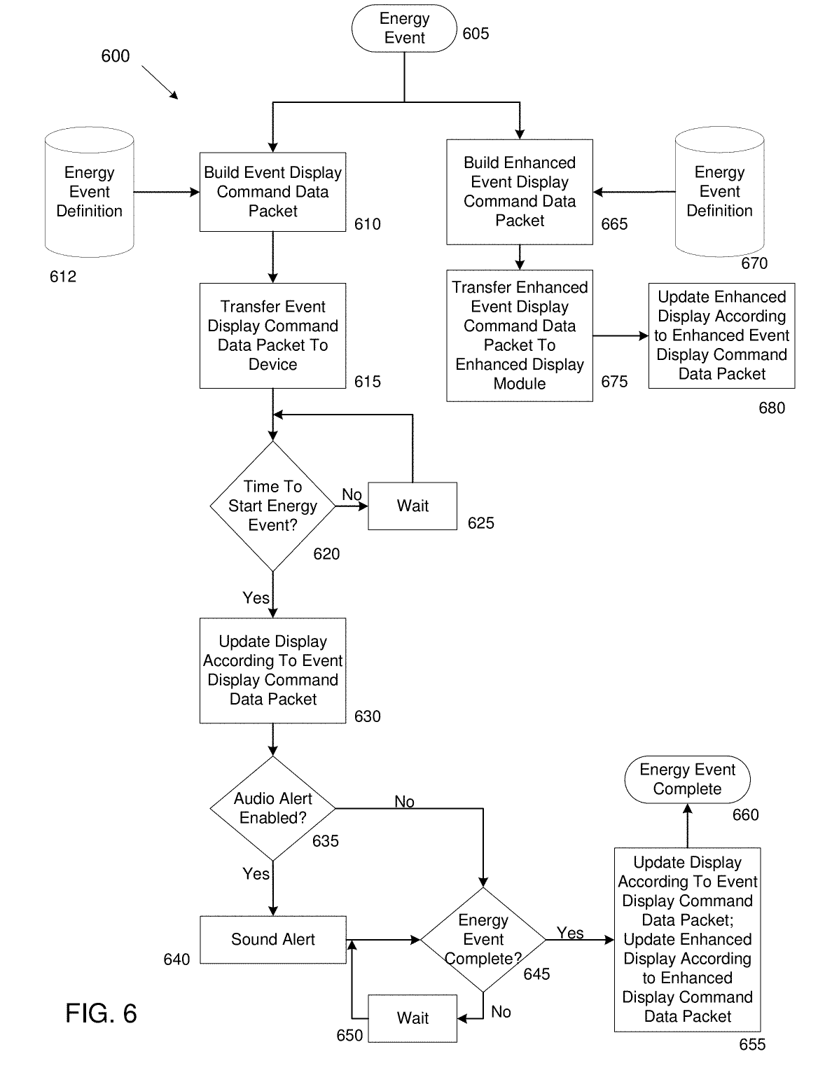

FIG. 6 illustrates an exemplary process 600 describing an energy event sequence of system 300. Process 600 begins at step 605. When an energy event is scheduled by the service provider (e.g., utility), data services module 315 may create an event display command data packet describing an event start time, event duration and event behavior for indicators 325. An energy event may be, for example, a time period of peak demand of a utility by users, a time period in which prices are adjusted to account for significantly shifted supply or demand, and/or any other suitable event affecting usage of a service such as a utility by consumers. For example, data services module 315 may build an event display command data packet at step 610 based on event definition data such as energy event definition data obtained (e.g., by accessing databases stored and/or accessed by system 300) at step 612. At step 615, the event display command data packet may then be transferred by system 300 to assembly 305. Upon receiving the event display command data packet, assembly 305 may read the event display command data packet and store the data in local memory of assembly 305 (e.g., in a storage module of display assembly 345 or other suitable component of assembly 305).

At step 620, system 300 may determine whether or not a start time of an energy event has been reached based on the event display command data packet. If a start time has not been reached, system 300 may wait at step 625. When the event start time is reached at step 630, assembly 305 (e.g., display assembly 345) may decode the commands in the locally stored event display command data packet and set (e.g., update) display assembly 345 (e.g., including indicators 325) based on the behaviors specified in the event display command data packet. For example, assembly 305 may update display assembly 345 (e.g., including lighting display settings of indicators 325) based on the event display command data packet. Once assembly 305 has been updated, indicators 325 may be set to an updated behavior based on the current time (e.g., based on the actual time and the event display command data packet). For example, behaviors (e.g., lighting color, intensity, and/or flashing or steady lighting) of indicators 325 may be set based on the event display command data packet. Also for example, system 300 may determine at step 635 whether or not audio assembly 350 has been set to provide an audio alert. If audio assembly 350 has been set to emit an alert (e.g., an audio alert or any other suitable type of alert as disclosed, e.g., above), audio assembly 350 may emit an audio alert at step 640. For example, audio assembly 350 may emit an audio warning to a user based on the specified behavior disclosed for example above (e.g., indicating that an energy event is in progress).

At step 645, system 300 may determine whether or not an energy event is complete based on the event display command data packet. If an end time has not been reached, system 300 may wait at step 650. When the event end time is reached at step 655, assembly 305 (e.g., display assembly 345) may decode the commands in the locally stored event display command data packet and again set (e.g., update) display assembly 345 (e.g., including indicators 325) based on the behaviors specified in the latest locally stored display command data packet (e.g., at a current time). Assembly 305 may also update the exemplary enhanced display at step 655 based on the enhanced display command data packet as disclosed for example herein. Process 600 may end at step 660.

Also for example in process 600, data services module 315 may create an enhanced event display command data packet that contains for example the display command data packet as well as additional information regarding the event (e.g., the energy event) at step 665 based on event definition (e.g., energy event definition) obtained (e.g., by accessing databases stored and/or accessed by system 300) at step 670. The enhanced event display command data packet may be transferred from data services module 315 to enhanced display module 320 at step 675. For example, enhanced display module 320 may be updated at step 680 based on the enhanced event display command data packet. For example, the exemplary enhanced display disclosed for example herein may provide users (e.g., a consumer such as a utility customer) with additional event information (e.g., information regarding an energy event).

For example, when an energy event is scheduled (e.g., a demand response, a pricing event, and/or any other suitable event), data services module 315 may create an event display command data packet and an enhanced event command data packet. The event command data packet may define a start time and a duration of the energy event and the behavior of indicators 325 during the event. The enhanced event command data packet may include the event command data packet plus augmented information related to the energy event. The event command data packet may be transferred to assembly 305. Assembly 305 (e.g., display assembly 345) may read the new event command data packet and update indicators 325 accordingly. When the energy event starts, assembly 305 (e.g., display assembly 345) may set one or more indicators 325 to a unique behavior indicating the start and duration of the energy event. When the energy event expires, assembly 305 (e.g., display assembly 345) may restore indicators 325 to their previous behavior (e.g., lighting pattern, intensity, lighting color, and/or flashing or constant state) before the energy event began. The enhanced event command data packet may be transferred to enhanced display module 320 to for example mirror the event command data packet information as well as the augmented information. If audio assembly 350 is active, an audio tone may be emitted to alert users (e.g., a utility customer) of the energy event.

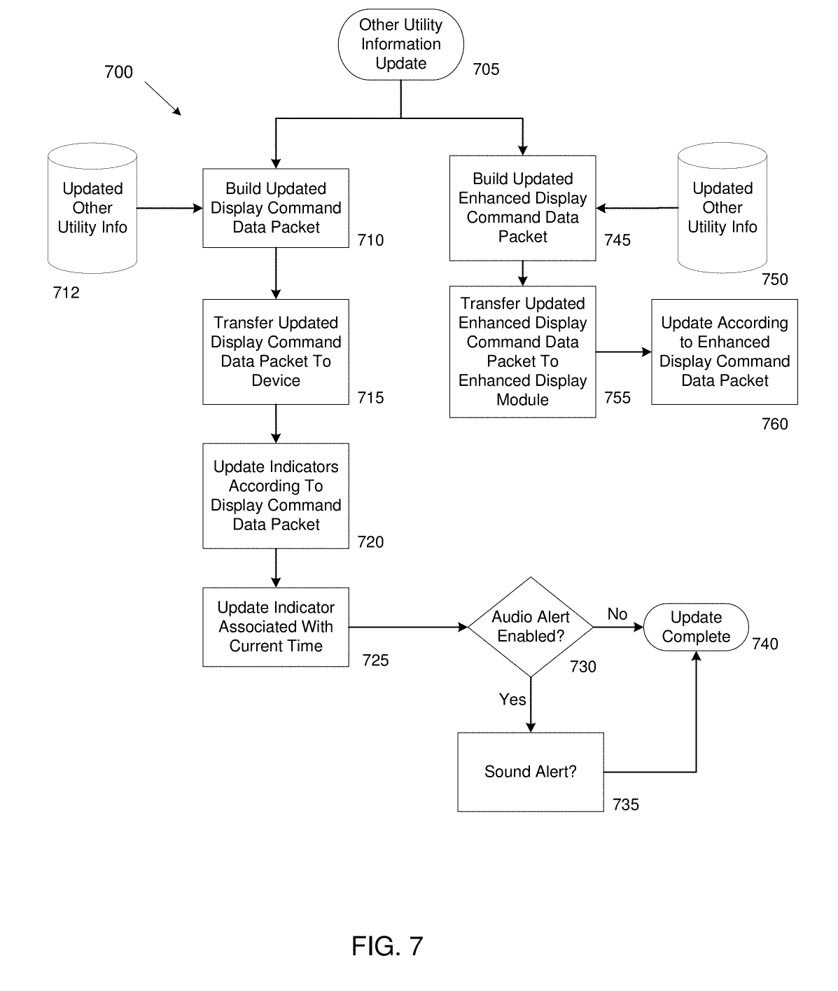

FIG. 7 illustrates an exemplary process 700 describing a utility information sequence of system 300. Process 700 begins at step 705. When other utility information is updated by the service provider (e.g., utility), data services module 315 may convert the other utility information change to a list of display behaviors and store them in the display command data packet. The other utility information (e.g., other utility information change) may be any suitable information relating to a service provider such as a utility. For example, other utility information may include any suitable information to assist a user in planning utility usage (e.g., when to water the user's lawn and/or when to charge the user's electric vehicle and/or other applicances). Also for example, the other utility information may be additional information related to pricing (e.g., average pricing, pricing trends, and/or pricing per unit of usage), average usage for selected time periods, information describing user behavior, and/or any other desired information related to relative utility pricing. For example, data services module 315 may build an updated display command data packet at step 710 based on updated other utility information obtained (e.g., by accessing databases stored and/or accessed by system 300) at step 712. At step 715, the display command data packet may then be transferred by system 300 to assembly 305.

Upon receipt of the display command data package, assembly 305 may read the display command data packet, decode the commands included in the display command data packet, and set (e.g., update) display assembly 345 (e.g., including indicators 325) based on the behaviors specified by the display command data package at step 720. For example, assembly 305 may update display assembly 345 (e.g., including lighting display settings of indicators 325) based on the display command data packet. Once assembly 305 been updated, indicators 325 may be set to an updated behavior based on the current time (e.g., based on the actual time and the display command data packet) at step 725. For example, behaviors (e.g., lighting color, intensity, and/or flashing or steady lighting) of indicators 325 may be set based on the display command data packet. Also for example, system 300 may determine at step 730 whether or not audio assembly 350 has been set to provide an audio alert. If audio assembly 350 has been set to emit an alert (e.g., an audio alert or any other suitable type of alert as disclosed, e.g., above), audio assembly 350 may emit an audio alert at step 735. For example, audio assembly 350 may emit an audio warning to a user based on the specified behavior disclosed for example above (e.g., indicating that other utility information has changed). Process 700 may end at step 740.

Also for example in process 700, data services module 315 may create an enhanced display command data packet that contains for example the display command data packet as well as other utility information (e.g., as disclosed for example above) at step 745 based on updated other utility information obtained (e.g., by accessing databases stored and/or accessed by system 300) at step 750. The enhanced display command data packet may be transferred from data services module 315 to enhanced display module 320 at step 755. For example, enhanced display module 320 may be updated at step 760 based on the enhanced display command data packet. For example, the exemplary enhanced display disclosed for example herein may provide users (e.g., a consumer such as a utility customer) with other utility information as disclosed for example above.

For example, when a change occurs regarding other utility information (e.g., as disclosed for example above), data services module 315 may read the change in other utility information and build a display command data packet and an enhanced display command data packet. The display command data packet may define the behavior of indicators 325. The enhanced display command data packet may include the display command data packet plus augmented information regarding the other utility information. The display command data packet may be transferred to assembly 305. Assembly 305 (e.g., display assembly 345) may read the new display command data packet and may update indicators 325 accordingly. The enhanced display command data packet may be transferred to the enhanced display module 320 to for example mirror the display command data packet information as well as the augmented information. If audio assembly 350 is active, an audio tone may be emitted to alert a user (e.g., a consumer such as a utility customer) of the change in other utility information.

For example, the exemplary disclosed method may allow a user to remotely access relative utility price information and/or additional (e.g., related) information, other utility information, and/or suggestions as to how to better utilize the awareness of the relative utility pricing schedule and/or the other utility information remotely via enhanced display module 320. Also for example, the exemplary disclosed method may provide a user with audible tones and/or alerts (e.g., or other types of alerts such as visual alerts), near real-time energy pricing event notifications, and/or remote access to pricing and additional information via remote command devices such as devices having mobile applications (apps).

Also for example, the exemplary disclosed method may provide a utility pricing schedule and/or additional information that is mapped to indicators 325 and/or an exemplary digital display (e.g., exemplary enhanced display). The provided information may indicate desirable available possible pricing and/or differentiating utility information over an upcoming period (e.g., next defined period). The exemplary disclosed method may also provide utility generated pricing changes and/or utility information that are updated without user interaction. The exemplary disclosed method may for example further provide utility-generated energy events and/or utility information changes that are updated without user interaction.

For example, the exemplary disclosed method may provide a variable utility pricing schedule information (e.g., a Time of Use schedule or “TOU” schedule) describing pricing based on the time of day that utility services are consumed. The exemplary disclosed method may for example provide users with information describing multi-tiered TOU rate schedules as well as communicating near real time changes to TOU rates to consumers.

Also for example, the exemplary disclosed method may include providing a relative utility pricing apparatus (e.g., assembly 305), providing a plurality of indicator lights (e.g., indicators 325) on a surface of the relative utility pricing apparatus, and transferring a data packet (e.g., display command data packet, updated display command data packet, updated enhanced display command data packet, event display command data packet, and/or enhanced event display command data packet) to the relative utility pricing apparatus. For example, the exemplary disclosed method may include providing data in the data packet indicating a first time period having a utility price that is lowest relative to a second time period, and controlling the plurality of indicator lights to indicate when the first time period occurs. For example, the first time period may be shorter than the second time period and may occur during the second time period. The data packet may for example include electric utility information or water utility information. The exemplary disclosed method may also include providing the data in the data packet to a remote computing device (e.g., an exemplary enhanced display and/or exemplary user interface as disclosed for example herein).

The exemplary disclosed system and method may provide an effective technique for transferring service provider information. For example, the exemplary disclosed system and method may allow customers to ascertain when relative pricing tiers may change, which may allow those users to make decisions as to when they should use certain energy devices. Also for example, the exemplary disclosed system and method may notify customers when a service provider such as a utility may transition into a pricing event, e.g., such as a critical peak pricing. Additionally for example, the exemplary disclosed system and method may provide a technique for storing pricing information and rates on a device that may be updated to represent non-scheduled changes such as holidays and seasonal changes. Also for example, the exemplary disclosed system and method may communicate utility usage information to customers and may provide augmented relative pricing, energy event and/or other utility information via an enhanced display module.

An illustrative representation of a computing device appropriate for use with embodiments of the system of the present disclosure is shown in FIG. 8. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 9, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 9, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 9, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A utility information system, comprising:
a data services module, comprising computer-executable code stored in non-volatile memory;
a processor; and
a notification device including one or more indicator display components that are user-visible;
wherein the data services module, the processor, and the notification device are configured to:
create a data packet including utility information;
transfer the data packet from the data services module to the notification device; and
control a display of the indicator display components, without user input, based on the data packet.

2. The utility information system of claim 1, wherein the utility information includes a utility pricing schedule.

3. The utility information system of claim 1, wherein the notification device includes an audio assembly configured to emit an audio alert.

4. The utility information system of claim 1, further comprising an enhanced display module.

5. The utility information system of claim 4, wherein the data services module, the enhanced display module, the processor, and the notification device are configured to create an enhanced data packet including the utility information and additional information.

6. The utility information system of claim 5, wherein the enhanced data packet is transferred to an enhanced display that is located remotely from the notification device.

7. The utility information system of claim 1, wherein the data services module, the processor, and the notification device are configured to create a second data packet including updated utility information.

8. The utility information system of claim 1, wherein the utility information includes a variable utility pricing Time of Use schedule describing pricing based on the time of day that utility services are consumed.

9. The utility information system of claim 1, wherein the utility information includes a scheduled energy event.

10. The utility information system of claim 1, further comprising a control application module that provides network credentials to the notification device.

11. The utility information system of claim 1, wherein the utility information includes electric utility information or water utility information.

12. An apparatus, comprising:
a housing;
one or more indicator display components that are disposed on a surface of the housing; and
a communications assembly;
wherein the communications assembly is configured to receive a data packet;
wherein the data packet includes data indicating a first time period having a utility price that is lowest relative to a second time period;
wherein the first time period is shorter than the second time period and both begins and ends during the second time period; and
wherein the one or more indicator display components operate to indicate when the first time period occurs.

13. The apparatus of claim 12, wherein the utility price that is lowest relative to the second time period is an electricity price.

14. The apparatus of claim 12, further comprising a power assembly and an audio assembly configured to emit an audio alert.

15. The apparatus of claim 14, wherein the power assembly includes an electrical plug.

16. A method, comprising:
providing a relative utility pricing apparatus;
providing a plurality of indicator lights on a surface of the relative utility pricing apparatus;
transferring a data packet to the relative utility pricing apparatus;
providing data in the data packet indicating a first time period having a utility price that is lowest relative to a second time period; and
controlling the plurality of indicator lights to indicate when the first time period occurs;
wherein the first time period is shorter than the second time period and occurs during the second time period.

17. The method of claim 16, wherein the data packet includes electric utility information or water utility information.

18. The method of claim 16, wherein the relative utility pricing apparatus includes an audio assembly configured to emit an audio alert.

19. The method of claim 16, wherein the utility price that is lowest relative to the second time period is an electricity price.

20. The method of claim 16, further comprising providing the data in the data packet to a remote computing device.
